(19) United States
(12) Patent Application Publication
(10) Pub. No.: US 2006/0139919 A1
(43) Pub. Date: Jun. 29, 2006

(54) Receiving container, backlight assembly having the receiving container, and display device having the backlight assembly

(76) Inventors: Seong-Sik Choi, Seoul (KR); Doo-Won Lee, Seoul (KR); Dong-Lyoul Shin, Suwon-si (KR)

Correspondence Address: CANTOR COLBURN, LLP, 55 GRIFFIN ROAD SOUTH, BLOOMFIELD, CT, 06002, US

(21) Appl. No.: 11/190,460

(22) Filed: Jul. 27, 2005

(30) Foreign Application Priority Data
Dec. 27, 2004 (KR) 2004-113049
Jan. 6, 2005 (KR) 2005-001186

(51) Int. Cl. F21V 17/00; F21V 13/10

(52) U.S. Cl. 362/240; 362/225; 362/235; 362/433

(57) ABSTRACT

In a receiving container, a backlight assembly having the receiving container, and a display device having the backlight assembly, the receiving container includes a bottom plate, sidewalls, and optical support members. The sidewalls extend from an edge of the bottom plate. The sidewalls are connected to each other to define a receiving recess therebetween. The optical support members protrude from a front face of the bottom plate to support optical units thereon. The optical support members are integrally formed with the bottom plate. The bottom mold is integrally formed with lamp supporters and/or dispersion plate support members. Thus, cost required for manufacturing the bottom mold is relatively low. In addition, time required for manufacturing the bottom mold is relatively short. Furthermore, a light leakage is prevented between the bottom mold and the optical support members.

This application claims priority to Korean Patent Application No. 2004-113049 filed on Dec. 27, 2004 and Korean Patent Application No. 2005-1186 filed on Jan. 6, 2005 and all the benefits accruing therefrom under 35 USC §119, and the contents of which in their entirety are herein incorporated by reference.

### BACKGROUND OF THE INVENTION

1. Field of the Invention

The present invention relates to a receiving container, a backlight assembly having the receiving container, and a display device having the backlight assembly. More particularly, the present invention relates to a receiving container having an optical support portion formed as one body, a backlight assembly having the receiving container, and a display device having the backlight assembly.

2. Description of the Related Art

One type of a backlight assembly employed in a display apparatus such as an LCD-TV includes a lamp assembly and optical sheets. The lamp assembly and the optical sheets are received on a bottom chassis where the bottom chassis includes a metal.

When the bottom chassis is formed by using aluminum or an iron plate plated with zinc, parts of the display apparatus must be combined with the bottom chassis such as by using a screw or a hook. As a result, the parts are not easily combined with or separated from the bottom chassis.

### BRIEF SUMMARY OF THE INVENTION

The present invention provides a receiving container having an optical support portion that may be integrally formed into one body.

The present invention also provides a backlight assembly having the receiving container.

The present invention also provides a display device having the backlight assembly.

In accordance with exemplary embodiments of a receiving container, the receiving container includes a bottom plate, sidewalls, and optical support members.

The sidewalls extend from an edge of the bottom plate. The sidewalls are connected to each other to define a receiving recess therebetween. The optical support members protrude from a front face of the bottom plate to support at least one optical unit thereon. The optical support members are integrally formed with the bottom plate.

In accordance with exemplary embodiments of a backlight assembly, the backlight assembly includes lamps and a receiving container. The lamps generate a light. The receiving container includes a bottom plate, sidewalls, and lamp support portions. The sidewalls extend from an edge of the bottom plate. The sidewalls are connected to each other to define a receiving recess therebetween. The lamp support portions protrude from a front face of the bottom plate to support the lamps thereon. The lamp support portions are integrally formed with the bottom plate.

In accordance with other exemplary embodiments of a backlight assembly, the backlight assembly includes lamp units, a dispersion plate, and a receiving container. The lamp units generate a light. The dispersion plate disperses the light passing therethrough. The receiving container includes a bottom plate, sidewalls, and dispersion plate support members. The sidewalls extend from an edge of the bottom plate. The sidewalls are connected to each other to define a receiving recess therebetween. The lamp units are received in the receiving recess. The dispersion plate support members protrude from a front face of the bottom plate to support the dispersion plate thereon. The dispersion plate support members are integrally formed with the bottom plate.

In accordance with exemplary embodiments of a display device, the display device includes a backlight assembly, a liquid crystal display panel, and a first receiving container. The backlight assembly generates a light having improved optical characteristics. The liquid crystal display panel displays an image by using the light. The first receiving container includes a bottom plate, sidewalls, and lamp support portions. The sidewalls are connected to each other. The sidewalls are connected to the bottom plate to define a receiving recess where the backlight assembly and the display panel are received. The lamp support portions protrude from a front face of the bottom plate and are integrally formed with the bottom plate.

In accordance with other exemplary embodiments of a display device, the display device includes a backlight assembly and a display panel. The backlight assembly includes lamps, a dispersion plate, and a receiving container. The lamps generate a light. The dispersion plate disperses the light passing therethrough. The receiving container includes a bottom plate, sidewalls, and dispersion plate support members. The sidewalls are connected to each other. The sidewalls are connected to the bottom plate to define a receiving recess where the lamps are received. The dispersion plate support members are protruded from a front face of the bottom plate to support the dispersion plate thereon. The dispersion plate support members are integrally formed with the bottom plate. The display panel is positioned over the backlight assembly. The display panel displays an image using the light supplied from the dispersion plate.

According to the embodiments described herein, a cost required for manufacturing the bottom mold may be relatively low. In addition, a time required for manufacturing the bottom mold may be reduced. Furthermore, light leakage may be limited between the bottom mold and the lamp supporters.

### BRIEF DESCRIPTION OF THE DRAWINGS

The above and other advantages of the present invention will become readily apparent by reference to the following detailed description when considered in conjunction with the accompanying drawings in which:

FIG. 1 is an exploded perspective view illustrating an exemplary embodiment of a liquid crystal display device in accordance with the present invention;

FIG. 2 is a partial enlarged perspective view illustrating an exemplary second side mold in FIG. 1;

FIG. 3 is a perspective view illustrating a front portion of an exemplary bottom mold in FIG. 1;

FIG. 4 is a perspective view illustrating a rear portion of the bottom mold in FIG. 1;

FIG. 5 is a cross-sectional view taken alone line I-I′ of the bottom mold in FIG. 3;

FIG. 6 is a plan view illustrating the front portion of the bottom mold in FIG. 1;

FIG. 7 is a plan view illustrating the rear portion of an exemplary upper mold in FIG. 1;

FIG. 8 is a partial perspective view illustrating another exemplary embodiment of a bottom mold in accordance with the present invention;

FIG. 9 is a partial perspective view illustrating another exemplary embodiment of a bottom mold in accordance with the present invention;

FIG. 10 is an exploded perspective view illustrating an exemplary embodiment of a liquid crystal display device in accordance with the present invention;

FIG. 11 is a perspective view illustrating a front portion of an exemplary bottom mold illustrated in FIG. 10;

FIG. 12 is a perspective view illustrating a rear portion of the bottom mold illustrated in FIG. 10; and

FIG. 13 is a cross-sectional view taken along line II-II′ in FIG. 11.

### DETAILED DESCRIPTION OF THE INVENTION

This invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of elements may be exaggerated for clarity.

Also, it will be understood that when an element or layer is referred to as being “on” or “connected to” another element, it can be directly on or directly connected to the other element or intervening elements may be present.

Like reference numerals refer to like elements throughout.

It will be understood that, although the terms first, second, etc. may be used herein to describe various elements, these elements should not be limited by these terms. These terms are only used to distinguish one element from another element. Thus, for example, a first element discussed below could be termed a second element without departing from the teachings of the present invention.

Spatially relative terms, such as “beneath”, “lower”, “upper” and the like, may be used herein for ease of description to describe one element's relationship to another element(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements would then be oriented “above” the other elements. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of elements but do not preclude the presence or addition of one or more other elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention are described herein with reference to cross-section illustrations that are schematic illustrations of embodiments of the present invention. Variations from the shapes of the illustrations as a result of design choices not affecting the scope of the invention, manufacturing techniques and/or tolerances are to be expected. Thus, embodiments of the present invention should not be construed as limited to the particular shapes of elements illustrated herein but are to include deviations in shapes that result from manufacturing or design choices that do not affect the scope of the invention. Thus, the elements illustrated in the figures are schematic in nature and their shapes are not intended to illustrate the precise shape of an element of a device and are not intended to limit the scope of the present invention.

Various embodiments of the present invention will now be described with reference to the accompanying drawings.

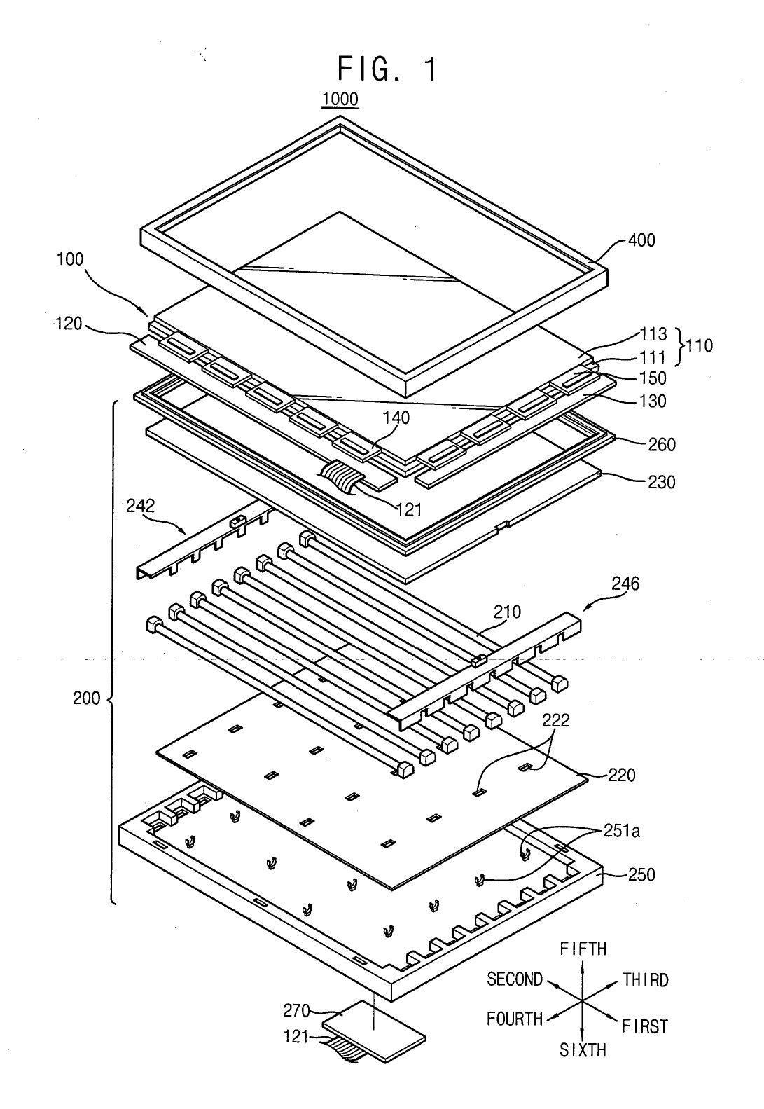

FIG. 1 is an exploded perspective view illustrating an exemplary embodiment of a liquid crystal display device 1000. In particular, the liquid crystal display device 1000 has a direct illumination type lamp unit 210.

Referring to FIG. 1, a liquid crystal display device 1000 includes a display unit 100 and a backlight assembly 200. When an electrical image signal is applied to the display unit 100, the display unit 100 may control a light transmittance of a liquid crystal layer (not shown) included in a liquid crystal panel 110 of the display unit 100. Thus, the display unit 100 may display an image. The backlight assembly 200 provides the display unit 100 with light.

The display unit 100 includes the liquid crystal panel 110, a data printed circuit board (“PCB”) 120, a gate PCB 130, a data tape carrier package (“TCP”) 140, and a gate TCP 150. The liquid crystal panel 110 displays an image by using rearrangements of liquid crystal molecules in the liquid crystal layer of the liquid crystal panel 110.

The data and gate PCBs 120 and 130 provide the liquid crystal panel 110 with drive signals and timing signals, respectively. The data TCP 140 electrically connects the data PCB 120 to a data line included in a thin film transistor (“TFT”) substrate 111 of the liquid crystal panel 110. The gate TCP 150 electrically connects the gate PCB 130 to a gate line included in the TFT substrate 111 of the liquid crystal display panel 110. The data and gate TCPs 140 and 150 may enable the liquid crystal display device 1000 to encompass a relatively small area.

The liquid crystal panel 110 displays the image. The liquid crystal panel 110 includes the TFT substrate 111, a color filter substrate 113, and the liquid crystal layer (not shown). The color filter substrate 113 faces the TFT substrate 111. The liquid crystal layer is positioned between the TFT substrate 111 and the color filter substrate 113. The TFT substrate 111 is frequently referred to as an array substrate. The TFT substrate 111 may be a transparent glass substrate and includes TFTs (not shown) that are arranged in a matrix shape. The data line is connected with source terminals of the TFTs. The gate line is connected to gate terminals of the TFTs. A pixel electrode including a transparent conductive material such as indium tin oxide (“ITO”) is formed on a drain terminal of the TFT.

The color filter substrate 113 includes a black matrix layer and color pixels. The color pixels may include a red pixel, a green pixel and/or a blue pixel. A red ray of a light incident on the red pixel selectively passes through the red pixel. A green ray of a light incident on the green pixel selectively passes through the green pixel. A blue ray of a light incident on the blue pixel selectively passes through the blue pixel. The black matrix layer is formed between the color pixels by a thin film process. The black matrix layer increases a contrast of a light irradiated from the color pixels. A common electrode is formed on a front face of the color filter substrate 113. The common electrode may include a transparent material such as ITO.

As previously described, the data TCP 140 electrically connects the data line included in the liquid crystal panel 110 to the data PCB 120. The gate TCP 150 electrically connects the gate line to the gate PCB 130. After external signals are applied to the data and gate PCBs 120 and 130, the data and gate PCBs 120 and 130 generate the driving signals and the timing signals, respectively. The driving signals and the timing signals are translated to the data line and the gate line through the data TCP 140 and the gate TCP 150, respectively. The driving signals are used for driving the display unit 100. The timing signals are used for driving the display unit 100 at a desired timing.

The backlight assembly 200 includes a plurality of lamp units 210, a dispersion plate 230, and a reflection plate 220. The lamp units 210 generate a light. The dispersion plate 230 is positioned over the lamp units 210, and is thus positioned between the lamp units 210 and the display unit 100. A light is supplied from the lamp units 210 and the reflection plate 220 to the dispersion plate 230. When the light passes through the dispersion plate 230, the dispersion plate 230 may disperse the light. Thus, a brightness distribution of the light passing through the dispersion plate 230 may be substantially uniform. The reflection plate 220 is positioned under the lamp units 210, and is thus positioned between the lamp units 210 and a bottom mold 250, as will be further described below. A light incident on the reflection plate 220 may be reflected toward the dispersion plate 230 by the reflection plate 220.

As illustrated in FIG. 1, each lamp unit 210 includes a lamp and lamp holders. Each lamp holder covers an end portion of a lamp. While the illustrated lamp holders each hold one lamp end portion, it should be understood that each lamp holder may hold two or more end portions of adjacent lamps. In the illustrated embodiment, the lamp has a bar shape, such that a longitudinal axis of the lamp passes through a first end portion of the lamp and a second end portion of the lamp. Alternatively, the lamp may have a U shape or an S shape. In a U-shaped lamp, for example, the lamp has two parallel light emitting portions and a rounded portion connecting two adjacent end portions of the parallel light emitting portions. Alternatively designed Lamp holders for rounded portions of the U-shaped or S-shaped lamps may be included as necessary. The lamp may be a cold cathode fluorescent lamp (“CCFL”). A lamp electrode of the CCFL is positioned inside the CCFL. Alternatively, the lamp may be an external electrode lamp (“EEFL”). A lamp electrode of the EEFL is positioned outside the EEFL. In addition, a light-emitting diode (“LED”), such as LEDs arranged in stripes, tubes, or bars, may be used as a light source instead of the lamp unit 210.

The lamp units 210, the reflection plate 220, and the dispersion plate 230 are received and fixed in a receiving container. Thus, external impacts may limit damage to the lamp units 210, the reflection plate 220, and the dispersion plate 230.

The receiving container includes a first side mold 242, a second side mold 246, a bottom mold 250, and an upper mold 260. The first side mold 242, the second side mold 246, the bottom mold 250, and the upper mold 260 may include a material capable of being efficiently used in an injection molding process. Thus, the first side mold 242, the second side mold 246, the bottom mold 250, and the upper mold 260 may be formed by an injection molding process using an injection molding machine. Other manufacturing processes, such as other molding processes, are also within the scope of these embodiments.

The bottom mold 250 receives the reflection plate 220, the lamp units 210, the first side mold 242, and the second side mold 246. The bottom mold 250 may exemplararily include, but is not limited to, polycarbonate (“PC”). Polycarbonate has a substantially high injection molding ability, a substantially high thermal endurance, and a substantially high mechanical reliability such as an impact endurance. Other materials with similar qualities may also be employed for the bottom mold 250.

Lamp supporters 251a, for supporting the lamp units 210, protrude from the bottom mold 250 in a fifth direction. That is, the lamp supporters 251a extend in a direction substantially perpendicular to a bottom plate 251 of the bottom mold 250. The lamp supporters 251a may be integrally formed with the bottom mold 250. That is, during the manufacture of the bottom mold 250, the lamp supporters 251a may be formed during the same molding process.

The lamp supporters 251a receive bodies of the lamps having the bar shape, and may have a generally circular cross-section, although other cross-sections are within the scope of the lamp units 210. The lamp supporters 251a have a clip shape that may be forced open slightly for receiving a lamp therein. The clip shape includes a pair of wing members that are biased towards each other, thus holding the lamp relative to the bottom mold 250. Reflection plate holes 222 are formed through the reflection plate 220. The reflection plate holes 222 correspond to the lamp supporters 251a. Thus, when the reflection plate 220 is placed within the bottom mold 250, the lamp supporters 251a pass through the reflection plate holes 222 of the reflection plate 220.

A control PCB 270 is positioned beneath a rear face of the bottom mold 250. A flexible printed circuit board (“FPCB”) 121 connects the control PCB 270 to the data PCB 120. The FPCB 121 is inserted into a connector (not shown) of the control PCB 270.

The control PCB 270 provides the FPCB 121 with signals used for driving the liquid crystal panel 110. The FPCB 121 provides the data PCB 120 with the signals.

Although not illustrated in FIG. 1, a substrate cover may be combined with the bottom mold 250 to cover the control PCB 270, thus preventing external impurities from damaging the control PCB 270.

The upper mold 260 is positioned on the dispersion plate 230. The upper mold 260 contacts the dispersion plate 230. In addition, the upper mold 260 applies pressure to the dispersion plate 230 so that the dispersion plate 230, the first side mold 242, and the second side mold 246 are firmly fixed between the upper mold 260 and the bottom mold 250. The liquid crystal panel 110 is positioned on the upper mold 260. The data PCB 120 connected to the data line of the TFT substrate 111 included in the liquid crystal panel 110 may make contact with a lower sidewall of the bottom mold 250. Alternatively, the data PCB 120 may make contact with the rear face of the bottom mold 250. The data PCB 120 may be angled relative to a surface of the liquid crystal panel 110 for contacting a lower sidewall or rear face of the bottom mold 250.

A top chassis 400 is positioned on the liquid crystal panel 110. The top chassis 400 includes four sidewalls and a bent portion. The bent portion is angled relative to the sidewalls, such as lying in a plane substantially perpendicular to each of the four sidewalls. The bent portion may define a top wall of the top chassis. The bent portion may prevent the display unit 100 positioned on the dispersion plate 230 from being separated from the dispersion plate 230. The top chassis 400 has an opening at a central portion thereof. That is, the bent portion defines the opening, where the opening forms a frame around the liquid crystal panel 110. The top chassis 400 applies pressure to an edge portion of the liquid crystal panel 110. The top chassis 400 is combined with the bottom mold 250 so that the liquid crystal panel 110 may be fixed to the bottom mold 250.

As described above, the backlight assembly 200 includes the bottom mold 250 instead of a conventional bottom chassis including a metal. The bottom mold 250 may be integrally formed with the lamp supporters 251a such as by an injection molding process. Thus, a cost required for manufacturing the backlight assembly 200 including the bottom mold 250 may be reduced. In addition, a weight of the backlight assembly 200 including the bottom mold 250 may decrease. Furthermore, a cost required for manufacturing the liquid crystal display device 1000 including the backlight assembly 200 may also be reduced. In addition, a weight of the liquid crystal display device 1000 including the backlight assembly 200 may decrease.

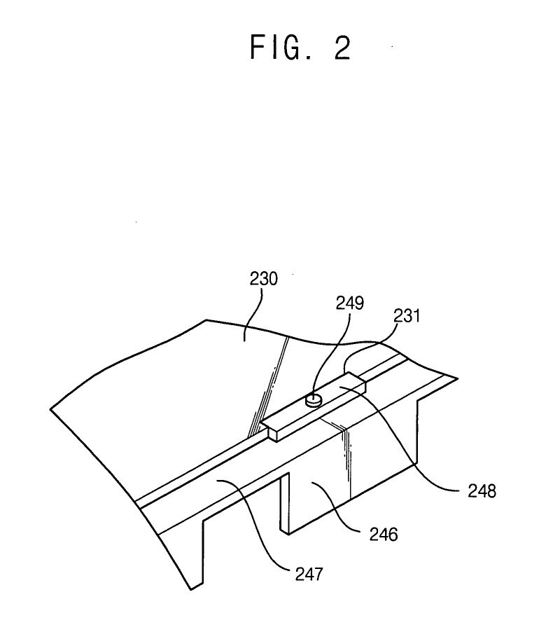

FIG. 2 is a partially enlarged perspective view illustrating the second side mold 246 in FIG. 1. The first side mold 242 is substantially identical to the second side mold 246, although, in alternate embodiments, the first side mold 242 may differ from the second side mold 246.

Referring to FIG. 2, the dispersion plate 230 and an optical sheet member (not shown) are positioned on the second side mold 246.

A first fixing portion 248 upwardly protrudes from an upper face 247 of the second side mold 246. A second fixing portion 249 upwardly protrudes from the first fixing portion 248.

The dispersion plate 230 includes a first recessed portion 231 indented into an edge surface of the dispersion plate 230. The first recessed portion 231 is combined with the first fixing portion 248 so that the dispersion plate 230 may remain stationary relative to the second side mold 246. While the first recessed portion 231 and the first fixing portion 248 are shown to have matching rectangular peripheries, it would be within the scope of these embodiments to include alternate matching peripheries, such as, but not limited to, rounded, jagged, etc.

The optical sheet member includes a second recessed portion (not shown). The second recessed portion may include a circular aperture within the optical sheet member to correspond in shape with the circular cross-section of the second fixing portion 249. Alternatively, the second recessed portion and the second fixing portion 249 may have alternate corresponding shapes. The second recessed portion is combined with the second fixing portion 249 so that the optical sheet may remain stationary relative to the dispersion sheet 230.

As illustrated in FIG. 2, the second fixing portion 249 is upwardly protruded from the first fixing portion 248. However, the second fixing portion 249 may alternatively be upwardly protruded from the upper face 247 of the second side mold 246.

Although not illustrated, a third fixing portion upwardly protrudes from an upper face of the first side mold 242. A fourth fixing portion upwardly protrudes from the third fixing portion. The dispersion plate 230 includes a third recessed portion. The third recessed portion is combined with the third fixing portion so that the dispersion plate 230 may remain stationary relative to the first side mold 242. The optical sheet member includes a fourth recessed portion (not shown). The fourth recessed portion is combined with the fourth fixing portion so that the optical sheet may remain stationary relative to the dispersion sheet 230. As described above, the fourth fixing portion is upwardly protruded from the third fixing portion. However, the fourth fixing portion may alternatively be upwardly protruded from the upper face of the first side mold 242.

The first fixing portion 248 may face the third fixing portion. However, many apparent variations of positions of the first fixing portion and the second fixing portion are possible according to positions of the first recessed portion 231 and the third recessed portion of the dispersion plate 230. Also, while only one fixing portion is disclosed for each opposing edge of the dispersion plate, and only one fixing portion is disclosed for each opposing edge of the optical sheet member, it should be understood that any number of fixing portions for fixing both the dispersion plate and the optical sheet member may be used on each side mold 242, 246.

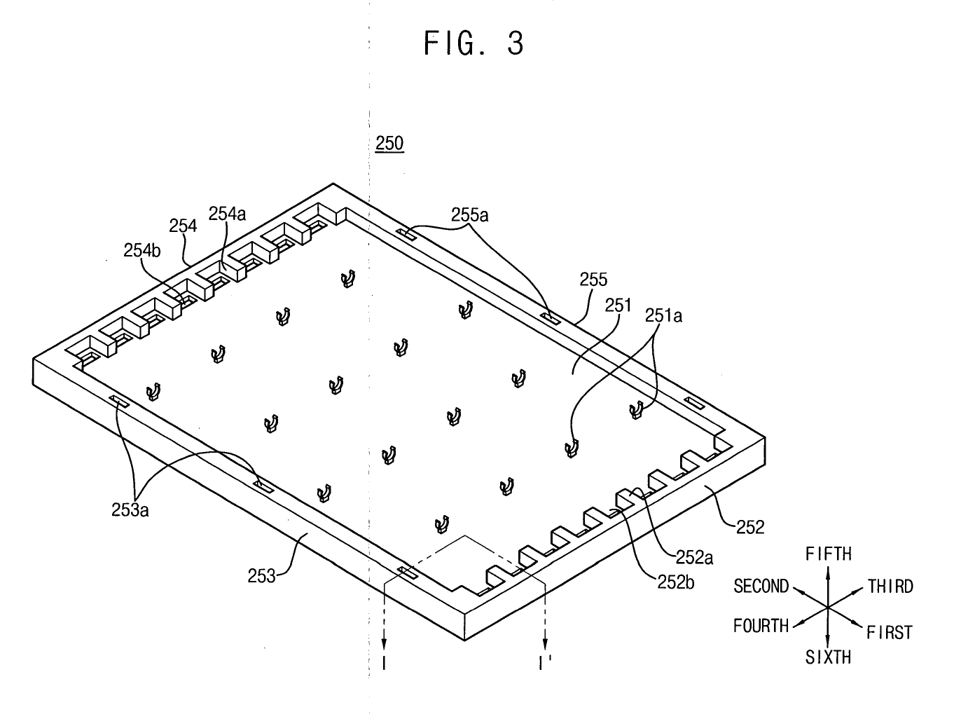

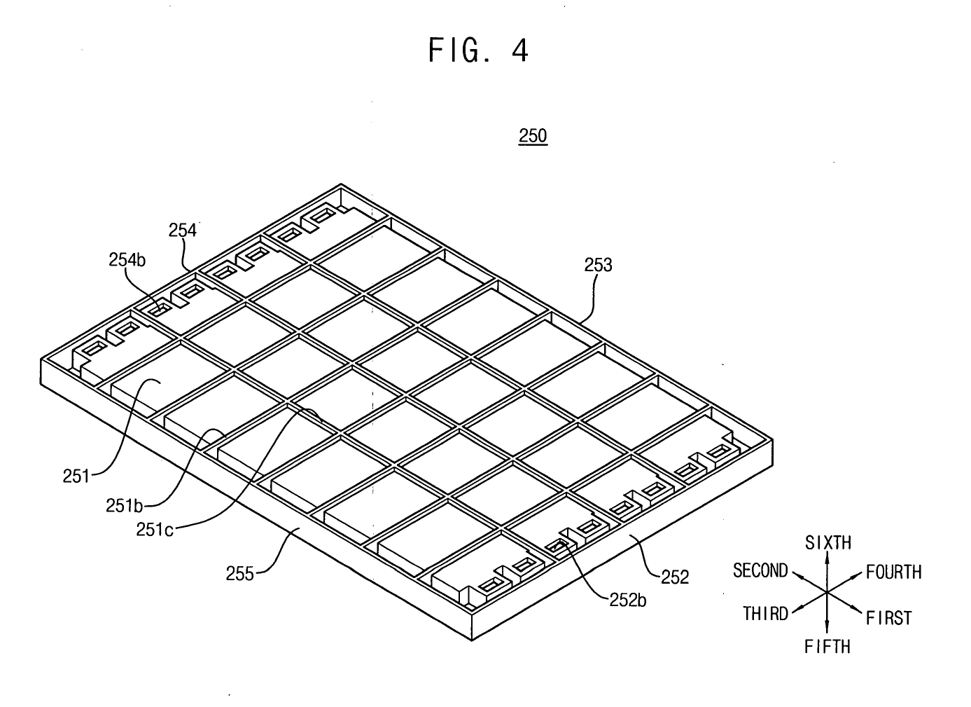

FIG. 3 is a perspective view illustrating a front portion of the bottom mold 250 in FIG. 1. FIG. 4 is a perspective view illustrating a rear portion of the bottom mold 250 in FIG. 1.

Referring to FIGS. 1 to 4, the bottom mold 250 includes a bottom plate 251, the lamp supporters 251a, a first lower sidewall 252, a second lower sidewall 253, a third lower sidewall 254, a fourth lower sidewall 255, first ribs 251b, and second ribs 251c. In one exemplary embodiment, the entire bottom mold 250, including, but not limited to, the bottom plate 251, the lamp supporters 251a, a first lower sidewall 252, a second lower sidewall 253, a third lower sidewall 254, a fourth lower sidewall 255, first ribs 251b, and second ribs 251c, may be unitarily molded during a single molding process, such as an injection molding process, to form a solitary unit.

The lamp supporters 251a are protruded from a front face of the bottom plate 251 in the fifth direction. That is, the lamp supporters 251a extend in a direction generally parallel with lower sidewalls 252, 253, 254, 255. The first lower sidewall 252, the second lower sidewall 253, the third lower sidewall 254, and the fourth lower sidewall 255 are thus also protruded from the bottom plate 251 in the fifth direction. The front face of the bottom plate 251, the first lower sidewall 252, the second lower sidewall 253, the third lower sidewall 254, and the fourth lower sidewall 255 together define a receiving recess for other elements within the backlight assembly 200.

The first ribs 251b and the second ribs 251c are protruded from a rear face of the bottom plate 251 in a sixth direction. That is, the first and second ribs 251b, 251c extend substantially perpendicular to a planar surface of the bottom plate 251. The first ribs 251b and the second ribs 251c together may prevent the bottom plate 251 from being easily bent, and therefore provide structural rigidity and strength to the bottom plate 251.

The first lower sidewall 252 protrudes from a first edge of the bottom plate 251 in the fifth direction. The first lower sidewall 252 includes first protrusions 252a that protrude in a second direction, where the second direction is generally parallel to the second and fourth lower sidewalls 253, 255. First lower holes 252b are formed through portions of the bottom plate 251, the portions being positioned between the first protrusions 252a. The lamp holders covering end portions of the lamps within the lamp units 210 are receivable in the first lower holes 252b.

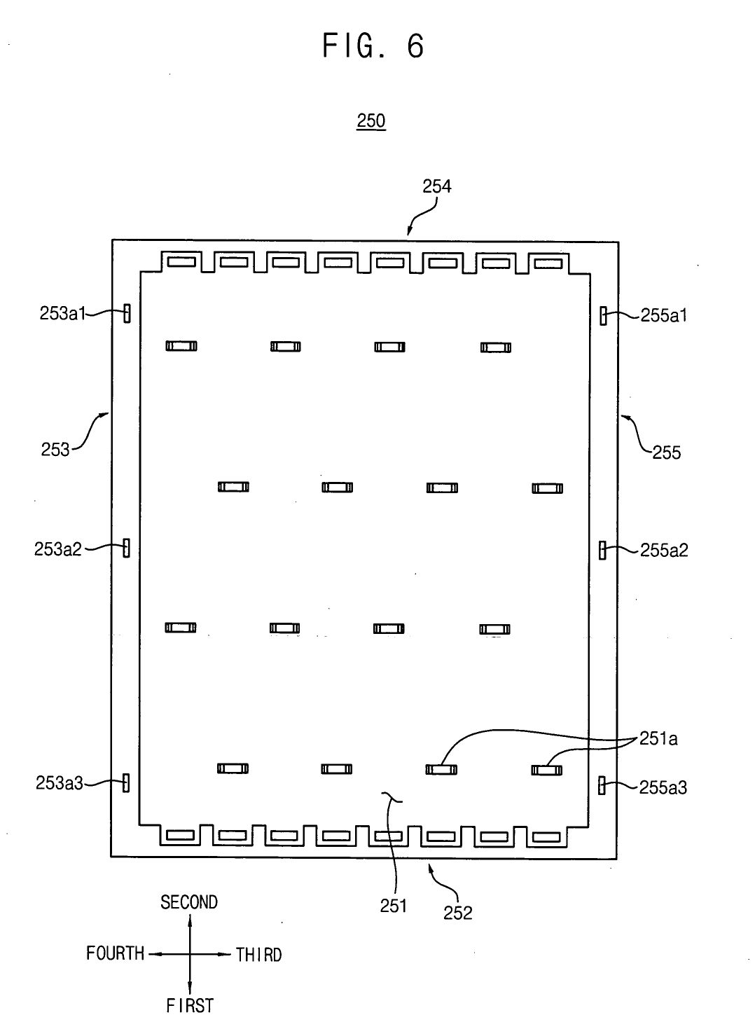

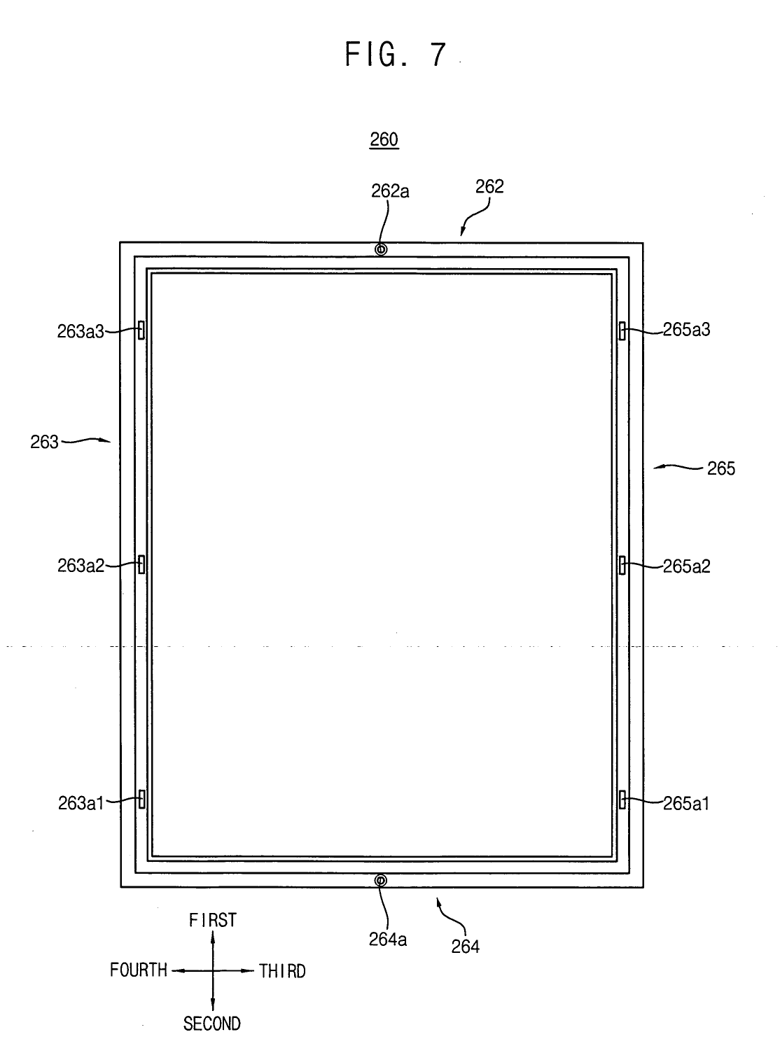

The second lower sidewall 253 is connected to the first lower sidewall 252, and may be substantially perpendicular to the first lower sidewall 252, and generally parallel with the first protrusions 252a. The second lower sidewall 253 protrudes from a second edge of the bottom plate 251 in the fifth direction. Second lower holes 253a are formed through the second lower sidewall 253. The second lower holes 253a may enable the bottom mold 250 to be combined with the upper mold 260, as will be further described below with respect to FIGS. 6 and 7.

The third lower sidewall 254 is connected to the second lower sidewall 253, and may be substantially perpendicular with the second lower sidewall 253, and generally parallel with the first lower sidewall 252. The third lower sidewall 254 protrudes from a third edge of the bottom plate 251 in the fifth direction. The third lower sidewall 254 includes second protrusions 254a that protrude in a first direction, substantially perpendicular to the third lower sidewall 254, generally parallel to the second and fourth lower sidewalls 253, 255, and to the first protrusions 252a. Third lower holes 254b are formed through portions of the bottom plate 251, the portions being positioned between the second protrusions 254a. The lamp holders are receivable in the third lower holes 254b.

The fourth lower sidewall 255 is connected to the first lower sidewall 252 and the third lower sidewall 254, and may be substantially perpendicular to both the first and third lower sidewalls 252, 254, and generally parallel to the second lower sidewall 253. The fourth lower sidewall 255 protrudes from a fourth edge of the bottom plate 251 in the fifth direction. Fourth lower holes 255a are formed through the fourth lower sidewall 255. The fourth lower holes 255a may enable the bottom mold 250 to be combined with the upper mold 260, as will be further described below with respect to FIGS. 6 and 7.

The first ribs 251b are substantially in parallel with the first lower sidewall 252 and the third lower sidewall 254. The first ribs 251b are formed beneath the rear face of the bottom plate 251. The first ribs 251b may enable the bottom plate 251 to have limited bendability in a third direction and a fourth direction.

The second ribs 251c are substantially in parallel with the second lower sidewall 253 and the fourth lower sidewall 255. The second ribs 251c are formed beneath the rear face of the bottom plate 251. The second ribs 251c may enable the bottom plate 251 have limited bendability in the first direction and the second direction.

As illustrated in FIGS. 3 and 4, the bottom plate 251 includes both the first ribs 251b and the second ribs 251c. Alternatively, the bottom plate 251 may include either the first ribs 251b or the second ribs 251c. Alternatively, the bottom plate 251 may include neither the first ribs 251b nor the second ribs 251c. Furthermore, while the illustrated bottom mold 250 includes a certain number of first ribs 251b and second ribs 251c, it should be understood that any number of first and second ribs 251b and 251c may be used to provide strength to the bottom mold 250.

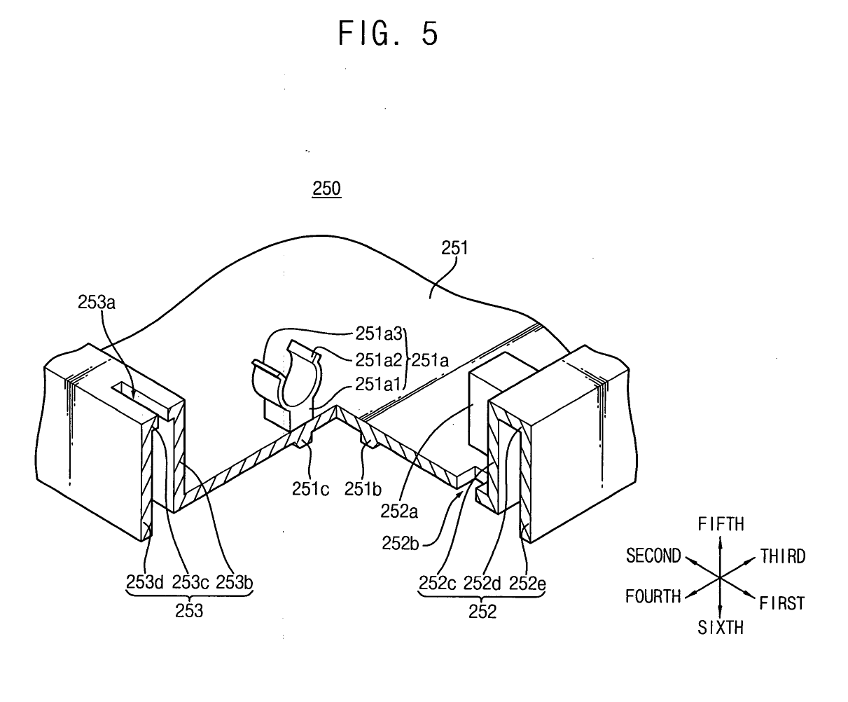

FIG. 5 is a cross-sectional view taken along line I-I′ of the bottom mold 250 in FIG. 3. In particular, the bottom mold 250 may have the lamp supporters 251a that are formed on a front face of the bottom plate 251.

Referring to FIG. 5, the lamp supporters 251a are formed on the front face of the bottom plate 251. The lamp supporters 251a are protruded from the front face of the bottom plate 251 in the fifth direction to support the bodies of the lamps. Each lamp supporter 251a includes a support member 251a1, a first wing member 251a2 and a second wing member 251a3. The support member 251a1 is protruded from the front face of the bottom plate 251 in the fifth direction. The first wing member 251a2 extends from the support member 251a1 in the fourth direction and the fifth direction. The second wing member 251a3 extends from the support member 251a1 in the third direction and the fifth direction. Together, the first and second wing members 251a2 and 251a3 form a generally U-shaped clip for receiving a lamp body therein. Each first and second wing member 251a2 and 251a3 may include a curved flange for matching a curved surface of the lamp body. Thus, the first wing member 251a2 and the second wing member 251a3 together support the body of the lamp that is received therebetween.

The first lower sidewall 252 extending from the first edge of the bottom plate 251 includes a first member 252c, a second member 252d, and a third member 252e.

The first member 252c protrudes from the first edge of the bottom plate 251 in the fifth direction, such as substantially perpendicular to the bottom plate 251. The second member 252d is connected to the first member 252c. The second member 252d extends in the first direction, such as substantially perpendicular to the first member 252c. The third member 252e is connected to the second member 252d. The third member 252e extends in the sixth direction, such as substantially perpendicular to the second member 252d.

As illustrated in FIG. 5, the first member 252c forms a substantially right angle with the bottom plate 251. However, the first member 252c may form an acute angle with the bottom plate 251, and the second and third members 252d and 252e may be arranged at various angles with respect to the first member 252c as deemed appropriate.

The second lower sidewall 253 protruding from the second edge of the bottom plate 251 in the fifth direction includes a fourth member 253b, a fifth member 253c, and a sixth member 253d. The fourth member 253b protrudes from the second edge of the bottom plate 251 in the fifth direction, such as substantially perpendicular to the bottom plate 251. The fifth member 253c is connected to the fourth member 253b. The fifth member 253b extends in the fourth direction, such as substantially perpendicular to the fourth member 253b. The sixth member 253d is connected to the fifth member 253c. The sixth member 253d extends from the fifth member 253c in the sixth direction, such as substantially perpendicular to the fifth member 253c. The third lower holes 253a are formed through the fifth member 253c. The second lower holes 253a may enable the bottom mold 250 to be combined with the upper mold 260, as will be further described below with respect to FIGS. 6 and 7.

As also illustrated in FIG. 5, the fourth member 253b forms a substantially right angle with the bottom plate 251. However, the fourth member 253b may form an acute angle with the bottom plate 251, and the fifth and sixth members 253c and 253d may be arranged at various angles with respect to the fourth member 253b as deemed appropriate.

As further illustrated in FIG. 5, the bottom plate 251 includes both the first ribs 251b and the second ribs 251c. Alternatively, the bottom plate 251 may include either the first ribs 251b or the second ribs 251c. Alternatively, the bottom plate 251 may include neither the first ribs 251b nor the second ribs 251c.

FIG. 6 is a plan view illustrating the front portion of the bottom mold 250 in FIG. 1. FIG. 7 is a plan view illustrating the rear portion of the upper mold 260 in FIG. 1.

Referring to FIGS. 1 to 7, the upper mold 260 includes a first upper sidewall 262, a second upper sidewall 263, a third upper sidewall 264, and a fourth upper sidewall 265 so that the upper mold 260 may have a frame shape. That is, the first upper sidewall 262, the second upper sidewall 263, the third upper sidewall 264, and the fourth upper sidewall 265 together define the upper mold 260. The first upper sidewall 262 and the third upper sidewall 264 are substantially parallel to each other and with the fourth direction and the third direction. A first upper hole 262a is formed through the first upper sidewall 262. The first upper hole 262a may be combined with the second fixing portion 249 of the second side mold 246. The second upper hole 264a is formed through the third upper sidewall 264. The second upper hole 264a may be combined with the fourth fixing portion of the first side mold 242. While first and second upper holes 262a and 264a are provided on the upper mold 260 for combining with the second fixing portion 249 and fourth fixing portion of the second and first side molds 246, 242, alternatively, the upper mold 260 may include the second and fourth fixing portions, while the first and second side molds 242, 246 may include first and second holes provided for combining with the second and fourth fixing portions on the upper mold 260.

The upper mold 260 has an extended portion. The extended portion is inwardly extended from the first upper sidewall 262, the second upper sidewall 263, the third upper sidewall 264, and the fourth upper sidewall 265. The extended portion forms a rectangular shape with a central opening. A first hook combination portion 263a1, a second hook combination portion 263a2, a third hook combination portion 263a3, a fourth hook combination portion 265a1, a fifth hook combination portion 265a2, and a sixth hook combination portion 265a3 protrude from the extended portion in the sixth direction. The first hook combination portion 263a1, the second hook combination portion 263a2, and the third hook combination portion 263a3 are formed in the extended portion adjacent the second upper sidewall 263 and are combined with the second lower holes 253a in the second lower sidewall 253 of the bottom mold 250. In particular, each hook combination portion 263a1, 263a2, 263a3 is insertable within a respective lower hole 253a1, 253a2, and 253a3, and prevents inadvertent dislocation of the upper mold 260 from the bottom mold 250. The fourth hook combination portion 265a1, the fifth hook combination portion 265a2, and the sixth hook combination portion 265a3 are formed adjacent the fourth upper sidewall 265 and are combined with the fourth lower holes 255a in the fourth lower sidewall 255 of the bottom mold 250. In particular, each hook combination portion 265a1, 265a2, and 265a3 is insertable within a respective lower hole 255a1, 255a2, 255a3, and further prevents inadvertent dislocation of the upper mold 260 from the bottom mold 250.

While the hook combination portions are disclosed on the upper mold 260 for combining with lower holes in the bottom mold 250, in an alternative embodiment, the hook combination portions may be provided in the bottom mold 250 and the holes for receiving the hook combination portions may be provided in the upper mold 260. Also, it should be understood that other connection devices may be provided for connecting the upper mold 260 with the bottom mold 250.

The extended portion may contact edges of the optical sheet member to support the optical sheet member. The optical sheet member may include a dispersion sheet, a condensing sheet or a protection sheet. These may be used alone or in a combination thereof.

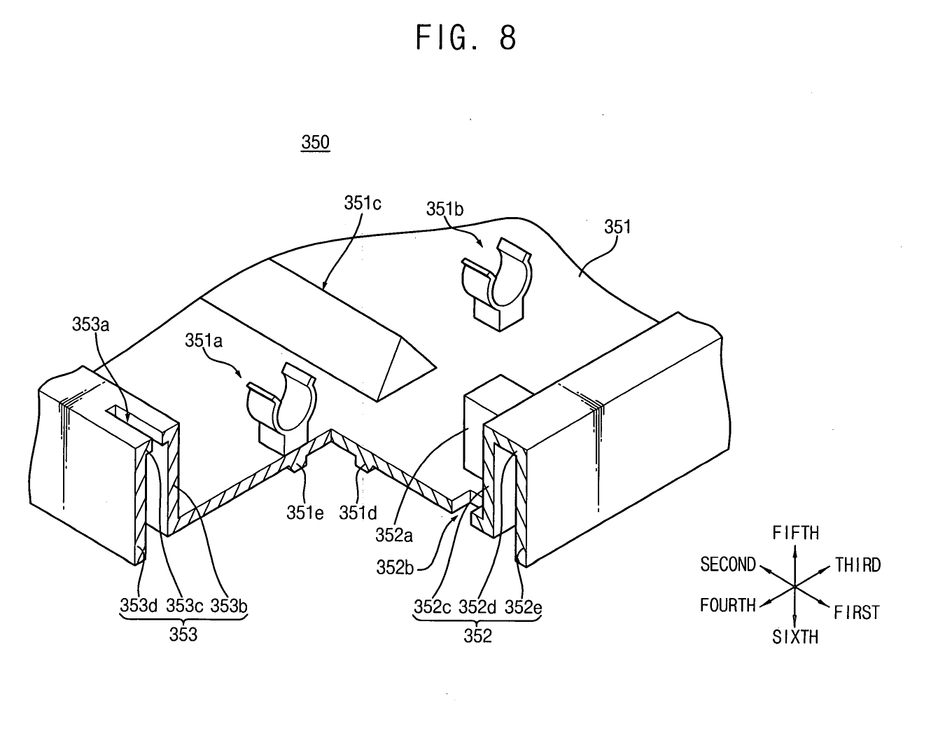

FIG. 8 is a partial perspective view illustrating another exemplary embodiment of a bottom mold 350. The bottom mold 350 is usable within the liquid crystal display device 1000 of FIG. 1 in place of the bottom mold 250. The bottom mold 350 includes a bottom plate 351. A protrusion 351c having a triangular prism shape is formed on a front face of the bottom plate 351.

Referring to FIG. 8, a first lamp supporter 351a and a second lamp supporter 351b protrude from a front face of the bottom plate 351 in a fifth direction substantially perpendicular to the bottom plate 351. The first lamp supporter 351a and the second lamp supporter 351b may support bodies of lamps. A protrusion 351c protrudes between the first lamp supporter 351a and the second lamp supporter 351b in the fifth direction. As similarly described above with reference to FIG. 5, the first lamp supporter 351a includes a support member, a first wing member and a second wing member. The support member protrudes from the front face of the bottom plate 351 in the fifth direction. The first wing member protrudes from the support member in the fifth direction and a fourth direction. The second wing member protrudes from the support member in the fifth direction and a third direction. The first wing member and the second wing member together have a U shape so that the body of the lamp may be received between the first wing member and the second wing member. The first and second wing members may be partially separable for receiving the lamp body therein. The protrusion 351c extends in a second direction along a surface of the bottom plate 351. The protrusion 351c prevents the bottom plate 351 from being easily bent, and thus provides further structural rigidity to the bottom mold 350. While only one protrusion 351c is illustrated in FIG. 8, it should be understood that a plurality of protrusions 351c may be provided on bottom plate 351. Furthermore, while the protrusion 351c is illustrated as generally parallel with the second lower sidewall 353, the protrusion 351c may also be positioned so as to be generally parallel with the first lower sidewall 352. An ancillary reflection plate covers the protrusion 351c therewith. A reflection plate, such as reflection plate 220, may include appropriately sized slots for receiving the protrusions 351c there through. Thus, a light generated from the lamp may be efficiently reflected toward the fifth direction to the dispersion plate. As illustrated in FIG. 8, the first lamp supporter 351a faces the second lamp supporter 351b in a third direction. That is, the first and second lamp supporters 351a and 351b are aligned so as to be parallel with the fist lower sidewall 352. Alternatively, the first lamp supporter 351a and the second lamp supporter 351b may be alternately arranged in a zigzag shape with respect to the protrusion 351c.

A first lower sidewall 352 extending from a first edge of the bottom plate 351 includes a first member 352c, a second member 352d, and a third member 352e. The first member 352c protrudes from the first edge of the bottom plate 351 in the fifth direction, and may be substantially perpendicular to the bottom plate 351. The second member 352d is connected to the first member 352c. The second member 352d extends in a first direction, and may be substantially perpendicular to the first member 352c. The third member 352e is connected to the second member 352d. The third member 352e extends in a sixth direction, and may be substantially perpendicular to the second member 352d.

As illustrated in FIG. 8, the first member 352c forms a substantially right angle with the bottom plate 351. However, the first member 352c may form an acute angle with the bottom plate 351, and the second and third members 352d and 352e may be arranged at various angles with respect to the first member 352c as deemed appropriate.

A second lower sidewall 353 protruding from a second edge of the bottom plate 351 in the fifth direction includes a fourth member 353b, a fifth member 353c, and a sixth member 353d. The fourth member 353b protrudes from the second edge of the bottom plate 351 in the fifth direction, and may be substantially perpendicular to the bottom plate 351. The fifth member 353c is connected to the fourth member 353b. The fifth member 353c extends in the fourth direction, and may be substantially perpendicular to the fourth member 353b. The sixth member 353d is connected to the fifth member 353c. The sixth member 353d extends from the fifth member 353c in the sixth direction, and may be substantially perpendicular to the fifth member 353c.

Second lower holes 353a are formed through the fifth member 353c. The second lower holes 353a may enable the bottom mold 350 to be combined with an upper mold, such as upper mold 260, as similarly previously described with respect to FIGS. 6 and 7.

As further illustrated in FIG. 8, the fourth member 353b forms a substantially right angle with the bottom plate 351. However, the fourth member 353b may form an acute angle with the bottom plate 351, and the fifth and sixth members 353c and 353d may be arranged at various angles with respect to the fourth member 353b as deemed appropriate.

Also as illustrated in FIG. 8, a first rib 351d is formed beneath a rear face of the bottom plate 351. The first rib 351d extends in a third direction substantially parallel to the first lower sidewall 352. A second rib 351e is formed beneath the rear face of the bottom plate 351. The second rib 351e extends in the second direction substantially parallel to the second lower sidewall 353.

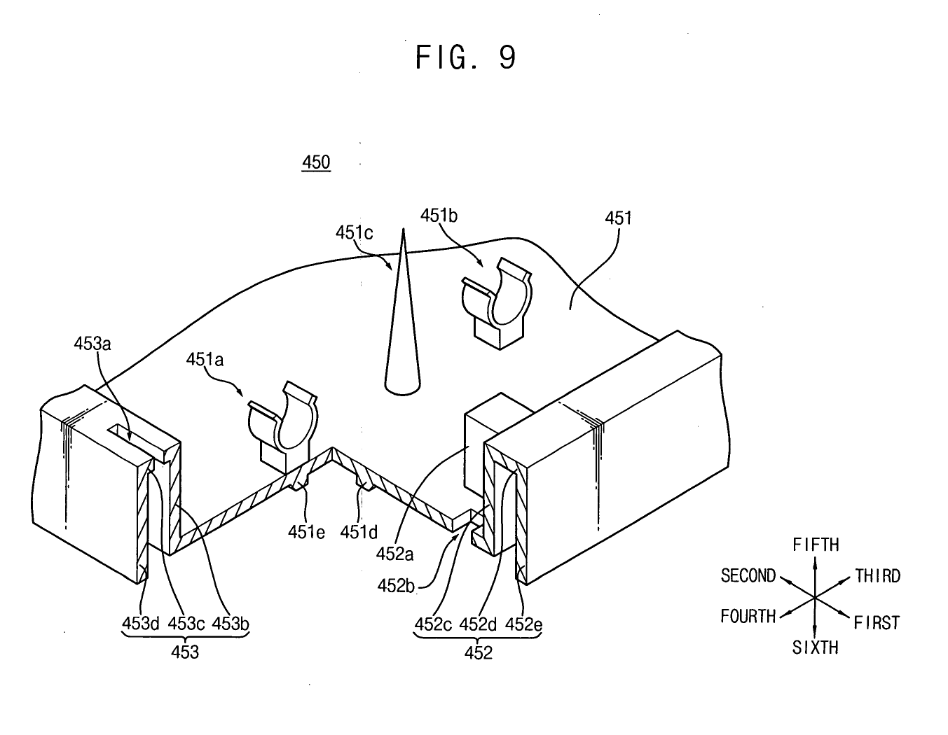

As further illustrated in FIG. 8, the first lower sidewall 352 includes first protrusions 352a that protrude in a second direction, where the second direction is generally parallel to the second lower sidewall 353. First lower holes 352b are formed through portions of the bottom plate 351, the portions being positioned between the first protrusions 352a. The lamp holders covering end portions of the lamps within the lamp units 210 are receivable in the first lower holes 352b. FIG. 9 is a partial perspective view illustrating another exemplary embodiment of a bottom mold. The bottom mold 450 is usable within the liquid crystal display device 1000 of FIG. 1 in place of the bottom mold 250. The bottom mold 450 includes a bottom plate 451. Lamp supporters 451a, 451b and dispersion plate support members 451c protrude from a front face of the bottom plate 451.

Referring to FIG. 9, a first lamp supporter 451a and a second lamp supporter 451b protrude from a front face of a bottom plate 451 in a fifth direction, such as substantially perpendicular to the bottom plate 451. The first lamp supporter 451a and the second lamp supporter 451b may support bodies of lamps. A dispersion plate support member 451c is protruded from a portion of the bottom plate 451 in the fifth direction, such as substantially perpendicular to the bottom plate 451. The dispersion plate support member 451c may support the dispersion plate, such as dispersion plate 230, thereon. While only two lamp supporters 451a, 451b and one dispersion plate support member 451c are illustrated in FIG. 9, it should be understood that a plurality of lamp supporters 451a, 451b and dispersion plate support members 451c may be distributed across the front face of the bottom plate 451 for adequately supporting the lamp units within the lamp supporters 451a, 451b and the dispersion plate 230 upon the dispersion plate support members 451c.

As similarly described above with reference to FIGS. 5 and 8, the first lamp supporter 451a includes a support member, a first wing member, and a second wing member. The support member protrudes from the front face of the bottom plate 451 in the fifth direction, such as substantially perpendicularly from the bottom plate 451. The first wing member protrudes from the support member in the fifth direction and a fourth direction. The second wing member protrudes from the support member in the fifth direction and a third direction. The first wing member and the second wing member together have a U shape so that the body of the lamp may be received between the first wing member and the second wing member. The first and second wing members may be partially separable for receiving the lamp body therein. As illustrated in FIG. 9, the first lamp supporter 451a faces the second lamp supporter 451b in a third direction, that is, they may be aligned with respect to the first lower sidewall 452. Alternatively, the first lamp supporter 451a and the second lamp supporter 451b may be alternately arranged in a zigzag shape, having varying distances from the first lower sidewall 452.

The dispersion plate support member 451c has a cone shape so that the dispersion plate support member 451c may support the dispersion plate 230 thereon. The dispersion plate support member 451c is integrally formed with the bottom mold 450. As illustrated in FIG. 9, the dispersion plate support member 451c has the cone shape. However, many apparent variations of the shapes of the dispersion plate support members 451c are possible. That is, the dispersion plate support member 451c may have, but are not limited to, a pyramid shape, a hexahedron shape, or a triangular pyramid shape.

Reflection plate holes 222 are formed through the reflection plate 220. While the reflection plate holes 222 have been previously described as corresponding to the lamp supporters, they may additionally correspond to the dispersion plate support members 451c. That is, the reflection plate 220 may include apertures sized for allowing the passage of both lamp supporters 451a, 451b and dispersion plate support members 451c therethrough such that the reflection plate 220 may be received upon the bottom plate 451.

A first lower sidewall 452 extending from a first edge of the bottom plate 451 includes a first member 452c, a second member 452d, and a third member 452e. The first member 452c protrudes from the first edge of the bottom plate 451 in the fifth direction, such as substantially perpendicularly from the bottom plate 451. The second member 452d is connected to the first member 452c. The second member 452d extends in a first direction, such as substantially perpendicular to the first member 452c. The third member 452e is connected to the second member 452d. The third member 452e extends in a sixth direction, such as substantially perpendicular to the second member 452d.

As illustrated in FIG. 9, the first member 452c forms a substantially right angle with the bottom plate 451. However, the first member 452c may form an acute angle with the bottom plate 451, and the second and third members 452d and 452e may be arranged at various angles with respect to the first member 452c as deemed appropriate.

A second lower sidewall 453 protruding from a second edge of the bottom plate 451 in the fifth direction includes a fourth member 453b, a fifth member 453c, and a sixth member 453d. The fourth member 453b protrudes from the second edge of the bottom plate 451 in the fifth direction, such as substantially perpendicular to the bottom plate 451. The fifth member 453c is connected to the fourth member 453b. The fifth member 453b extends in the fourth direction, such as substantially perpendicular to the fourth member 453b. The sixth member 453d is connected to the fifth member 453c. The sixth member 453d extends from the fifth member 453c in the sixth direction, such as substantially perpendicular to the fifth member 453c.

The first lower sidewall 452 includes first protrusions 452a that protrude in a second direction, where the second direction is generally parallel to the second lower sidewall 453. First lower holes 452b are formed through portions of the bottom plate 451, the portions being positioned between the first protrusions 452a. The lamp holders covering end portions of the lamps within the lamp units 210 are receivable in the first lower holes 452b.

Second lower holes 453a are formed through the fifth member 453c. The second lower holes 453a may enable the bottom mold 450 to be combined with an upper mold, such as upper mold 260, as similarly previously described with respect to FIGS. 6 and 7.

As illustrated in FIG. 9, the fourth member 453b forms a substantially right angle with the bottom plate 451. However, the fourth member 453b may form an acute angle with the bottom plate 451, and the fifth and sixth members 453c and 453d may be arranged at various angles with respect to the fourth member 453b as deemed appropriate.

As further illustrated in FIG. 9, a first rib 451d is formed beneath a rear face of the bottom plate 451. The first rib 451d extends in a third direction, such as substantially parallel to the first lower sidewall 452. A second rib 451e is formed beneath the rear face of the bottom plate 451. The second rib 451e extends in the second direction, such as substantially parallel to the second lower sidewall 453.

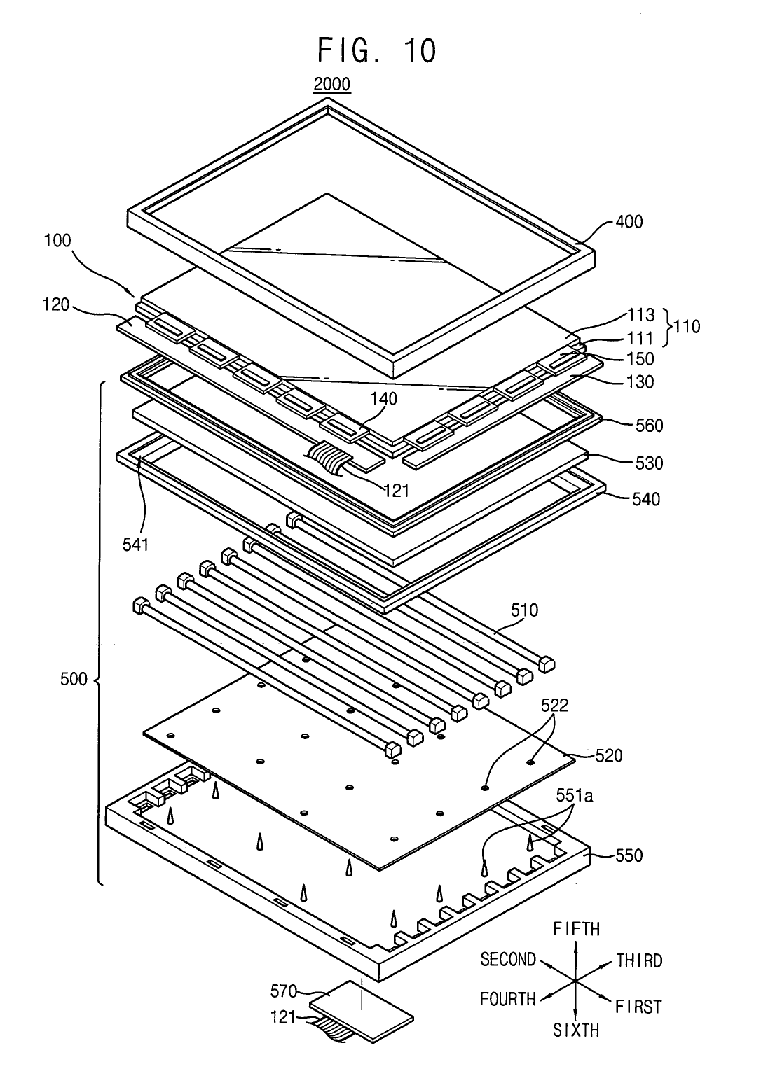

FIG. 10 is an exploded perspective view illustrating another exemplary embodiment of a liquid crystal display device.

Referring to FIG. 10, a liquid crystal display device 2000 includes a display unit 100 and a backlight unit 500. When an electrical image signal is applied to the display unit 100, the display unit 100 may control a light transmittance of a liquid crystal layer included in a liquid crystal panel 110 of the display unit 100. Thus, the display unit 100 may display an image. The backlight unit 500 provides the display unit 100 with a light. In FIG. 10, the same reference numerals denote the same elements in FIG. 1, and thus the detailed descriptions of the same elements will be omitted.

The backlight unit 500 includes a plurality of lamp units 510, a dispersion plate 530, and a reflection plate 520. The lamp units 510 generate a light. The dispersion plate 530 is positioned over the lamp units 510, and is thus positioned between the lamp units 510 and the liquid crystal panel 110. A light is supplied from the lamp units 510 and the reflection plate 520 to the dispersion plate 530. When the light passes through the dispersion plate 530, the dispersion plate 530 may disperse the light. Thus, a brightness distribution of the light passing through the dispersion plate 530 may be substantially uniform. The reflection plate 520 is positioned under the lamp units 510, and is thus positioned between the lamp units 510 and the bottom mold 550. A light incident on the reflection plate 520 may be reflected toward the dispersion plate 530 by the reflection plate 520.

The lamp units 510, the reflection plate 520, and the dispersion plate 530 are received in and fixed within a receiving container. Thus, external impacts may limit damage to the lamp units 510, the reflection plate 520, and the dispersion plate 530.

The receiving container includes a middle mold 540, a bottom mold 550, and an upper mold 560. The middle mold 540, the bottom mold 550, and the upper mold 560 may include a material capable of being efficiently used in an injection molding process. Thus, the middle mold 540, the bottom mold 550, and the upper mold 560 may be formed by an injection molding process using an injection molding machine. Other manufacturing processes, such as other molding processes, are also within the scope of these embodiments.

The middle mold 540 may receive the lamp units 510 to fix the lamp units 510 within the bottom mold 550. The middle mold 540 has a stepped portion 541 on an upper side of the middle mold 540 onto which the dispersion plate 530 is received thereon.

The bottom mold 550 may include a material capable of being efficiently used in the injection molding process. The bottom mold 550 receives the reflection plate 520, the lamp units 510, and the middle mold 540. The bottom mold 550 may include polycarbonate (“PC”). Polycarbonate has a substantially high injection molding ability, a substantially high thermal endurance, and a substantially high mechanical reliability such as an impact endurance. Alternate materials having similar characteristics would also be within the scope of these embodiments.

A plurality of dispersion plate support members 551a protrude from a front face of the bottom mold 550. The dispersion plate support members 551a support the dispersion plate 530 thereon. The dispersion plate support members 551a are integrally formed with the bottom mold 550. The dispersion plate support members 551a each have a cone shape so that the dispersion plate support members 551a may efficiently support the dispersion plate 530 thereon. As illustrated in FIG. 10, the dispersion plate support members 551a each have the cone shape, however, many apparent variations of the shapes of the dispersion plate members 551a are possible. That is, the dispersion plate support members 551a may have, but are not limited to, a pyramid shape, a hexahedron shape, or a triangular pyramid shape. A plurality of dispersion plate support members 551a are distributed about the bottom plate 551 of the bottom mold 550. While the plurality of dispersion plate support members 551a are fairly evenly distributed about the bottom plate 551 for evenly supporting the dispersion plate 530 thereon, each row of dispersion plate support members 551a may be alternatingly arranged with a row of dispersion plate support members 551a being offset from adjacent rows of dispersion plate support members 551a.

A plurality of combination holes 522 are formed through the reflection plate 520. The combination holes 522 correspond to the dispersion plate support members 551a. Thus, when the reflection plate 520 is placed within the bottom mold 550, the dispersion plate support members 551a pass through the combination holes 522.

A control PCB 570 is positioned beneath a rear face of the bottom mold 550. A flexible printed circuit board (“FPCB”) 121 connects the control PCB 570 to the data PCB 120. The FPCB 121 is inserted into a connector (not shown) of the control PCB 570.

The control PCB 570 provides the FPCB 121 with signals used for driving the liquid crystal panel 110. The FPCB 121 provides the data PCB 120 with the signals.

Although not illustrated in FIG. 10, a substrate cover may be combined with the bottom mold 550 to cover the control PCB 570, thus preventing external impurities from damaging the control PCB 570.

The upper mold 560 is positioned on the dispersion plate 530. The upper mold 560 contacts edge portions of the dispersion plate 530. In addition, the upper mold 560 applies pressure to the dispersion plate 530 so that the dispersion plate 530 and the middle mold 540 are firmly fixed between the upper mold 560 and the bottom mold 550. The liquid crystal panel 110 is positioned on the upper mold 560. Thus, the upper mold 560 is positioned between the liquid crystal panel 110 and the dispersion plate 530. The data PCB 120 connected to the data line of the TFT substrate 111 included in the liquid crystal panel 110 may make contact with a lower sidewall of the bottom mold 550. Alternatively, the data PCB 120 may make contact with the rear face of the bottom mold 550. The data PCB 120 bends with respect to the liquid crystal panel 110 to make contact with either the lower sidewall or the rear face of the bottom mold 550.

A top chassis 400 is positioned on the liquid crystal panel 110. The top chassis 400 includes four sidewalls and has a bent portion. The bent portion is angled relative to the sidewalls, such as lying in a plane substantially perpendicular to each of the four sidewalls. The bent portion may define a top wall of the top chassis. The bent portion may prevent the display unit 100 positioned on the dispersion plate 530 from being separated from the dispersion plate 530. The top chassis 400 has an opening at a central portion thereof. That is, the bent portion defines the opening, where the opening forms a frame around the liquid crystal panel 110. The top chassis 400 applies pressure to an edge portion of the liquid crystal panel 110. The top chassis 400 is combined with the bottom mold 550 so that the liquid crystal panel 110 may be fixed relative to the bottom mold 550.

As described above, the backlight unit 500 includes the bottom mold 550 instead of a conventional bottom chassis that includes a metal. The bottom mold 550 may be integrally formed with dispersion plate support members 551a by an injection molding process. Thus, a cost required for manufacturing the backlight unit 500 including the bottom mold 550 may be reduced. In addition, a weight of the backlight unit 500 including the bottom mold 550 may decrease. Furthermore, a cost required for manufacturing the liquid crystal display device 2000 including the backlight unit 500 may also be reduced. In addition, a weight of the liquid crystal display device 2000 including the backlight unit 500 may decrease.

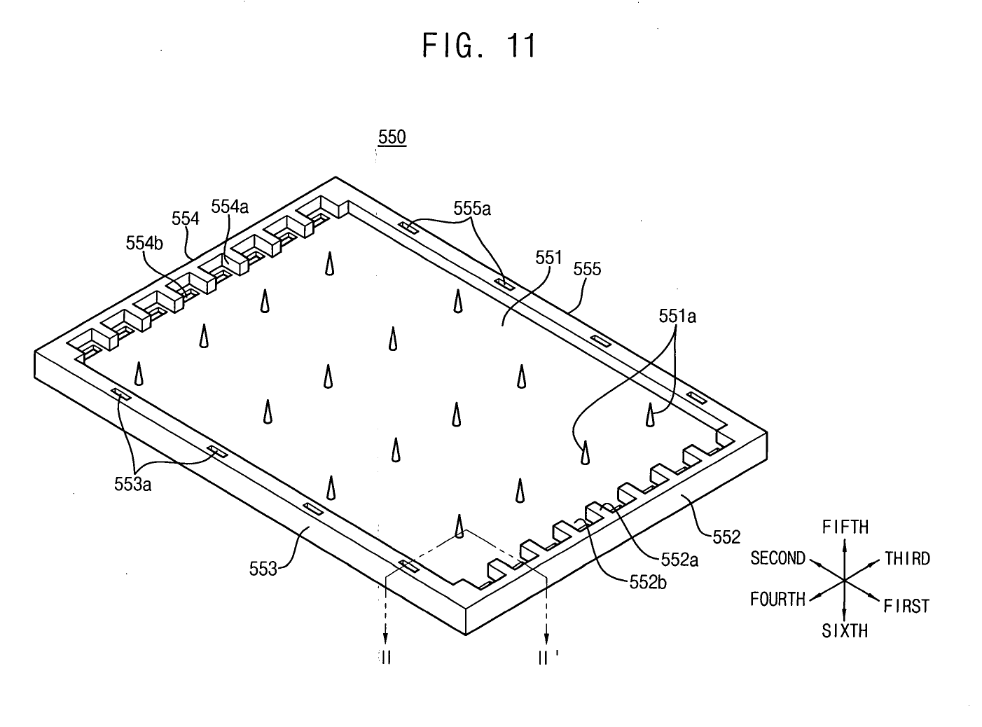

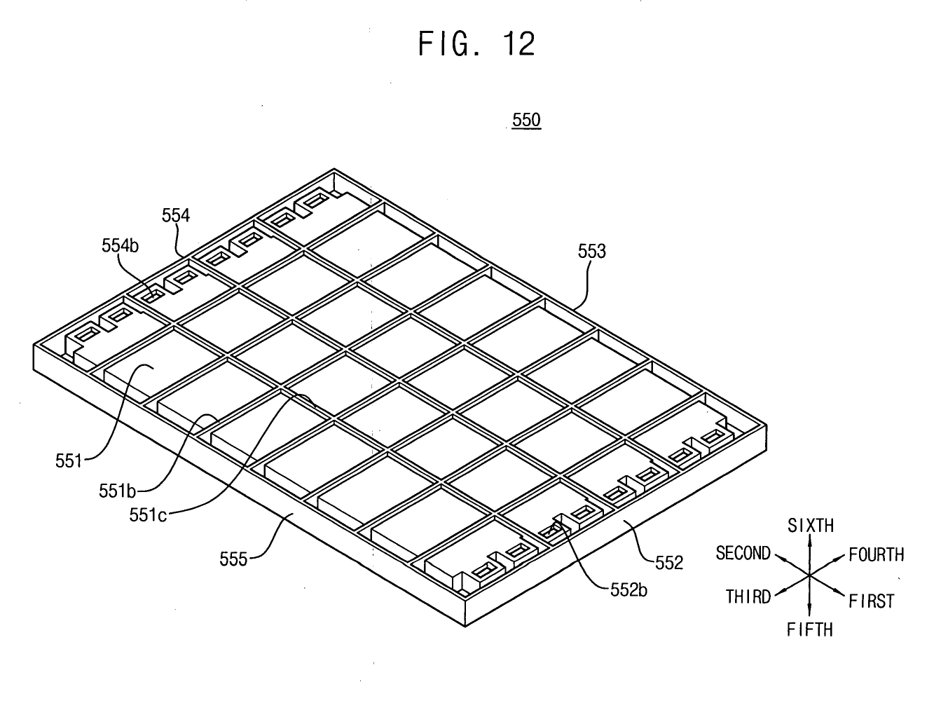

FIG. 11 is a perspective view illustrating a front portion of the bottom mold 550 illustrated in FIG. 10. FIG. 12 is a perspective view illustrating a rear portion of the bottom mold 550 illustrated in FIG. 10.

Referring to FIGS. 10 to 12, the bottom mold 550 includes a bottom plate 551, the dispersion plate support members 551a, a first lower sidewall 552, a second lower sidewall 553, a third lower sidewall 554, a fourth lower sidewall 555, first ribs 551b, and second ribs 551c.

The dispersion plate support members 551a are protruded from a front face of the bottom plate 551 in the fifth direction, that is, substantially perpendicular to the bottom plate 551. The first lower sidewall 552, the second lower sidewall 553, the third lower sidewall 554, and the fourth lower sidewall 555 are also protruded from the bottom plate 551 in the fifth direction. A front face of the bottom plate 551, the first lower sidewall 552, the second lower sidewall 553, the third lower sidewall 554, and the fourth lower sidewall 555 together define a receiving recess.

The first ribs 551b and the second ribs 551c are protruded from a rear face of the bottom plate 551 in a sixth direction, that is, substantially perpendicular to the bottom plate 551. The first ribs 551b and the second ribs 551c together may prevent the bottom plate 551 from being easily bent. That is, the first and second ribs 551b, 551c provide strength to the bottom plate 551.

The first lower sidewall 552 protrudes from a first edge of the bottom plate 551 in the fifth direction, such as, for example, substantially perpendicular to the bottom plate 551. The first lower sidewall 552 includes first protrusions 552a that protrude in a second direction, such as parallel to the second lower sidewall 553 and the fourth lower sidewall 555. First lower holes 552b are formed through portions of the bottom plate 551, the portions positioned between the first protrusions 552a. The lamp holders within the lamp units 510 covering end portions of the lamps are receivable in the first lower holes 552b.

The second lower sidewall 553 is connected to the first lower sidewall 552 and may be perpendicular to the first lower sidewall 552. The second lower sidewall 553 protrudes from a second edge of the bottom plate 551 in the fifth direction. Second lower holes 553a are formed through the second lower sidewall 553. The second lower holes 553a are combinable with the middle mold 540, as similarly previously described with respect to FIGS. 6 and 7, where the middle mold 540 may include hook combination portions.

The third lower sidewall 554 is connected to the second lower sidewall 553 and may be perpendicular to the second lower sidewall 553 and parallel to the first lower sidewall 552. The third lower sidewall 554 protrudes from a third edge of the bottom plate 551 in the fifth direction. The third lower sidewall 554 includes second protrusions 554a that protrude in a first direction, such as substantially parallel to the second and fourth lower sidewalls 553 and 555 as well as the first protrusions 552a. Third lower holes 554b are formed through portions of the bottom plate 551, the portions being positioned between the second protrusions 554a. The lamp holders are receivable in the third lower holes 554b.

The fourth lower sidewall 555 is connected to the first lower sidewall 552 and the third lower sidewall 554, and may be perpendicular to the first lower sidewall 552 and the third lower sidewall 554, and may further be parallel to the second lower sidewall 553. The fourth lower sidewall 555 protrudes from a fourth edge of the bottom plate 551 in the fifth direction. Fourth lower holes 555a are formed through the fourth lower sidewall 555. The fourth lower holes 555a are combinable with the middle mold 540, as similarly previously described with respect to FIGS. 6 and 7, where the middle mold 540 may include hook combination portions.

The first ribs 551b are substantially parallel with the first lower sidewall 552 and the third lower sidewall 554. The first ribs 551b are formed beneath the rear face of the bottom plate 551. The first ribs 551b may limit bending of the bottom plate 551 in a third direction and a fourth direction.

The second ribs 551c are substantially parallel with the second lower sidewall 553 and the fourth lower sidewall 555. The second ribs 551c are formed beneath the rear face of the bottom plate 551. The second ribs 551c may limit bending of the bottom plate 551 in the first direction and the second direction.

As illustrated in FIG. 12, the bottom plate 551 includes both the first ribs 551b and the second ribs 551c. Alternatively, the bottom plate 551 may include either the first ribs 551b or the second ribs 551c. As another alternative, the bottom plate 551 not neither the first ribs 551b nor the second ribs 551c. Also, while a certain number of ribs are illustrated, it would also be within the scope of these embodiments to provide more or less ribs for providing an appropriate a mount of strength and rigidity to the bottom plate 551.

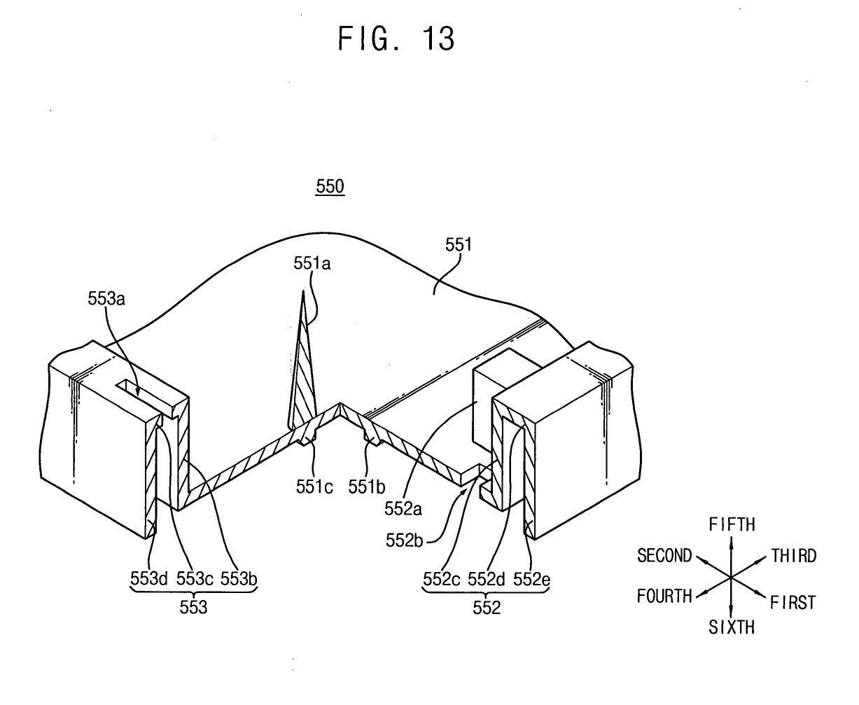

FIG. 13 is a cross-sectional view taken along line II-II′ in FIG. 11. The dispersion plate support members 551a protrude from the front face of the bottom plate 551.

Referring to FIG. 13, the dispersion plate support member 551a supporting the dispersion plate 530 thereon protrudes from the front face of the bottom plate 551 in the fifth direction. The dispersion plate support member 551a has a conical shape so that the dispersion plate support member 551a may efficiently support the dispersion plate 530. However, many apparent variations of the shapes of the dispersion plate support members 551a are possible. That is, the dispersion plate support members 551a may have, but are not limited to, a pyramid shape, a hexahedron shape or a triangular pyramid shape.

A first lower sidewall 552 extending from a first edge of the bottom plate 551 includes a first member 552c, a second member 552d, and a third member 552e. The first member 552c protrudes from the first edge of the bottom plate 551 in the fifth direction, such as substantially perpendicular to the bottom plate 551. The second member 552d is connected to the first member 552c. The second member 552d extends in a first direction, such as substantially perpendicular to the first member 552c. The third member 552e is connected to the second member 552d. The third member 552e extends in a sixth direction, such as substantially perpendicular to the second member 552d.

As illustrated in FIG. 13, the first member 552c forms a substantially right angle with the bottom plate 551. However, the first member 552c may form an acute angle with the bottom plate 551, and the second and third members 552d and 552e may be arranged at various angles with respect to the first member 552c as deemed appropriate.

A second lower sidewall 553 protruding from a second edge of the bottom plate 551 in the fifth direction includes a fourth member 553b, a fifth member 553c, and a sixth member 553d. The fourth member 553b protrudes from the second edge of the bottom plate 551 in the fifth direction, such as substantially perpendicular to the bottom plate 551. The fifth member 553c is connected to the fourth member 553b. The fifth member 553c extends in the fourth direction, such as substantially perpendicular to the fourth member 553b. The sixth member 553d is connected to the fifth member 553c. The sixth member 553d extends from the fifth member 553c in the sixth direction, such as substantially perpendicular to the fifth member 553c.

Second lower holes 553a are formed through the fifth member 553c. The second lower holes 553a are combinable with the middle mold 540, as similarly previously described with respect to FIGS. 6 and 7, where the middle mold 540 may include hook combination portions.

Also illustrated in FIG. 13, the fourth member 553b forms a substantially right angle with the bottom plate 551. However, the fourth member 553b may form an acute angle with the bottom plate 551, and the fifth and sixth members 553c and 553d may be arranged at various angles with respect to the first member 553b as deemed appropriate.

As further illustrated in FIG. 13, a first rib 551b is formed beneath a rear face of the bottom plate 551. The first rib 551b extends in a third direction, such as substantially parallel to the first lower sidewall 552. A second rib 551c is formed beneath the rear face of the bottom plate 551. The second rib 551c extends in the second direction, such as substantially parallel to the second lower sidewall 553. Thus, the illustrated first and second ribs 551b and 551c are substantially perpendicular to each other. Other arrangements of the ribs 551b and 551c are within the scope of these embodiments.

While embodiments have been described including lamp supporters and/or dispersion plate support members, it should be understood that any of the above-described embodiments may be combined to form other embodiments within the scope of this invention.

As described above, a backlight assembly includes a bottom mold integrally formed with lamp supporters by using a material substantially cheaper than a metal instead of a conventional bottom chassis including a metal. The bottom mold may be superior to the conventional bottom chassis in cost and time savings. That is, costs of materials and metal molds may be reduced. In addition, time required for manufacturing the bottom mold may also be saved.

Furthermore, when the conventional bottom chassis is combined with conventional lamp supporters, a light may leak between the conventional bottom chassis and the conventional lamp supporters. According to the present invention, the bottom mold has the lamp supporters that are integrally formed with the bottom mold, such as in a solitary unitary body. Thus, a light may not leak between the bottom mold and the lamp supporters.

In addition, the bottom mold of the embodiments described herein is formed by using a material substantially lighter than metal. Thus, the backlight assembly including the bottom mold and a liquid crystal display device is decreased in weight.

Furthermore, the material is capable of being efficiently used in an injection molding process. Thus, the backlight assembly having the bottom mold integrally molded with the lamp supporters and/or the dispersion plate support members eliminates a rattle noise that occurs in a conventional bottom chassis, and thus the backlight assembly of the embodiments disclosed herein may be substantially less noisy than that of the conventional bottom chassis.

In addition, a backlight assembly includes a bottom mold integrally formed with dispersion plate support members by using a material substantially cheaper than metal, in contrast to a conventional bottom chassis that includes metal. The bottom mold may be superior to the conventional bottom chassis in cost and time savings. That is, costs of materials and metal molds may be reduced. In addition, a time required for manufacturing the bottom mold may also be saved.

Furthermore, when the conventional bottom chassis is combined with conventional dispersion plate support members, light may leak between the conventional bottom chassis and the conventional dispersion plate support members. According to the present invention, the bottom mold has dispersion plate support members that are integrally formed with the bottom mold. Thus, light may not leak between the bottom mold and the dispersion plate support members.

In addition, the bottom mold is formed by using a material substantially lighter than metal. Thus, the backlight assembly including the bottom mold and a liquid crystal display device is decreased in weight.

Furthermore, the material is capable of being efficiently used in an injection molding process. Thus, the backlight assembly having the bottom mold integrally molded with the lamp supporters and/or the dispersion plate support members eliminates a rattle noise that occurs in a conventional bottom chassis, and thus the backlight assembly of the embodiments disclosed herein may be substantially less noisy than that of the conventional bottom chassis.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A receiving container comprising:
a bottom plate;
sidewalls extending from an edge of the bottom plate, the sidewalls connected to each other to define a receiving recess therebetween; and
support members protruding from a front face of the bottom plate to support at least one of a lamp and a dispersion plate thereon, the support members being integrally formed with the bottom plate,
wherein the receiving container is injection molded and the bottom plate and optical support members are molded in a solitary unit.

2. The receiving container of claim 1, wherein the bottom plate, the sidewalls and the support members include plastic.

3. The receiving container of claim 1, wherein the bottom plate, the sidewalls and the support members include polycarbonate.

4. The receiving container of claim 1, further comprising lower holes are formed through portions of the bottom plate adjacent to the sidewalls.

5. The receiving container of claim 1, wherein the support members support lamps thereon.

6. The receiving container of claim 5, wherein each support member comprises:
a first protrusion member protruding from the front face of the bottom plate; and
a second protrusion member protruding from the first protrusion member to partially cover a body of the lamp.

7. The receiving container of claim 5, wherein the sidewalls include first sidewalls and second sidewalls, the second sidewalls being substantially longer than the first sidewalls, the support members being arranged substantially parallel with the second sidewalls.

8. The receiving container of claim 5, wherein the sidewalls include first sidewalls and second sidewalls, the second sidewalls being substantially longer than the first sidewalls, the support members being arranged substantially parallel with the first sidewalls.

9. The receiving container of claim 1, further comprising lower holes formed through an edge portion of the bottom plate.

10. The receiving container of claim 9, wherein the sidewalls include first sidewalls and second sidewalls, the second sidewalls being substantially longer than the first sidewalls, and the lower holes being adjacent to the first sidewalls.

11. The receiving container of claim 9, wherein protrusion members upwardly protrude from portions of the bottom plate and each protrusion member is positioned between adjacent lower holes.

12. The receiving container of claim 1, further comprising a rib formed on a rear face of the bottom plate, the rib preventing the bottom plate from being easily bent.

13. The receiving container of claim 1, wherein the support members support a dispersion plate thereon.

14. The receiving container of claim 13, wherein each support member has a cone shape.

15. (canceled)

16. A backlight assembly comprising:
lamps generating a light; and
a receiving container including a bottom plate, sidewalls, and lamp support portions, the sidewalls extending from an edge of the bottom plate, the sidewalls connected to each other to define a receiving recess therebetween, the lamp support portions protruding from a front face of the bottom plate to support the lamps thereon, the lamp support portions being integrally formed with the bottom plate,
wherein the receiving container is injection molded and the bottom plate and lamp support portions are molded in a solitary unit.

17. The backlight assembly of claim 16, wherein the receiving container includes a material capable of being efficiently used in an injection molding process.

18. The backlight assembly of claim 16, further comprising a reflection layer covering the front face of the bottom plate.

19. The backlight assembly of claim 18, wherein the reflection layer includes aluminum.

20. The backlight assembly of claim 18, wherein the reflection layer has an irregular height.

21. The backlight assembly of claim 20, further comprising protrusions protruding from the bottom plate, each protrusion extending between adjacent lamps, wherein the protrusions are covered with an ancillary reflective surface.

22. The backlight assembly of claim 16, Her comprising a reflection layer covering the lamp support portions therewith.

23. The backlight assembly of claim 16, further comprising a reflection sheet having openings corresponding to the lamp support portions, the reflection sheet covering the bottom plate therewith.

24. The backlight assembly of claim 16, further comprising a reflection layer formed on the front face of the bottom plate and on inner faces of the sidewalls, the reflection layer including a transparent material.

25. (canceled)

26. A backlight assembly comprising:
lamp units generating a light;
a dispersion plate dispersing the light passing therethrough; and
a receiving container including a bottom plate, sidewalls, and dispersion plate support members, the sidewalls extending from an edge of the bottom plate, the sidewalls connected to each other to define a receiving recess therebetween, the lamp units received in the receiving recess, the dispersion plate support members protruding from a front face of the bottom plate to support the dispersion plate thereon, the dispersion plate support members being integrally formed with the bottom plate,
wherein the receiving container is injection molded and the bottom plate and dispersion plate support members are molded in a solitary unit.

27. The backlight assembly of claim 26, wherein the receiving container includes a material capable of being efficiently used in an injection molding process.

28. The backlight assembly of claim 26, wherein each lamp unit includes a lamp and lamp holders, the lamp holders covering end portions of the lamp, the receiving container further comprising combination holes formed through portions of the bottom plate adjacent to the sidewalls, wherein the lamp holders are combined with the combination holes.

29. (canceled)

30. A display device comprising:
a backlight assembly generating a light;
a liquid crystal display panel displaying an image by using the light; and
a first receiving container including a bottom plate; sidewalls, and lamp support portions, the sidewalls connected to each other and connected to the bottom plate to define a receiving recess where the backlight assembly and the display panel are received, the lamp support portions protruding from a front face of the bottom plate and integrally formed with the bottom plate, wherein the receiving container is injection molded and the bottom plate and the lamp support portions are molded in a solitary unit.

31. The display device of claim 30, wherein the backlight assembly comprises:
lamps supported on the lamp support portions;
a dispersion plate positioned between the lamps and the liquid crystal display panel, the dispersion plate having a first recessed portion and a second recessed portion;
a first side mold having a first fixing portion combined with the first recessed portion to fix the dispersion plate to the first side mold;
a second side mold having a second fixing portion combined with the second recessed portion to fix the dispersion plate to the second side mold; and
a second receiving container supporting the liquid crystal display panel thereon, the second receiving container combined with the first receiving container.

32. The display device of claim 31, wherein the backlight assembly comprises an optical sheet member, the first and second side molds having optical sheet member fixing portions for fixing the optical sheet member to the first and second side molds.

33. (canceled)

34. A display device comprising:
a backlight assembly including lamps, a dispersion plate, and a receiving container, the lamps generating a light, the dispersion plate dispersing the light passing therethrough, the receiving container including a bottom plate, sidewalls, and dispersion plate support members, the sidewalls connected to each other and connected to the bottom plate to define a receiving recess where the lamps are received, the dispersion plate support members being protruded from a front face of the bottom plate to support the dispersion plate thereon, the dispersion plate support members being integrally formed with the bottom plate; and
a display panel positioned over the backlight assembly, the display panel display an image using the light supplied from the dispersion plate,
wherein the receiving container is injection molded and the bottom plate and dispersion plate support members are molded in a solitary unit.

35. (canceled)

36. The display device of claim 34, further comprising lamp support portions for supporting the lamps relative to the bottom plate, the lamp support portions protruding from the front face of the bottom plate, wherein the lamp support portions are integrally molded with the bottom plate and dispersion plate support members.
